(19) United States
(12) Patent Application Publication
(10) Pub. No.: US 2025/0321728 A1
(43) Pub. Date: Oct. 16, 2025

(54) VEHICLE

(71) Applicant: TOYOTA JIDOSHA KABUSHIKI KAISHA, Toyota-shi (JP)

(72) Inventors: Yoshio WADA, Owariasahi-shi (JP); Yasutaka KOBAYASHI, Tajimi-shi (JP)

(73) Assignee: TOYOTA JIDOSHA KABUSHIKI KAISHA, Toyota-shi (JP)

(21) Appl. No.: 18/987,599

(22) Filed: Dec. 19, 2024

(30) Foreign Application Priority Data
Apr. 10, 2024 (JP) 2024-063479

(51) Int. Cl. G06F 8/65; B60R 16/033; B60R 25/01; B60R 25/24

(52) U.S. Cl. CPC G06F 8/65; B60R 16/033; B60R 25/24; B60R 25/01

(57) ABSTRACT

A vehicle for updating software used in an in-vehicle device by using update data received by wireless communication, the vehicle comprising: a power supply device; a housing portion for housing the power supply device; and a control device, wherein the housing portion includes an opening portion, an opening and closing body, and a locking mechanism for locking the opening and closing body in a state in which the opening and closing body closes the opening portion, wherein the control device is capable of executing a process of updating the software by receiving a supply of power from the power supply device, a process of switching the locking mechanism between a locked state and an unlocked state, and a process of switching the locking mechanism from the locked state to the unlocked state during the update of the software.

### CROSS-REFERENCE TO RELATED APPLICATION

This application claims priority to Japanese Patent Application No. 2024-063479 filed on Apr. 10, 2024, incorporated herein by reference in its entirety.

### BACKGROUND

### 1. Technical Field

The present disclosure relates to a vehicle.

### 2. Description of Related Art

Japanese Unexamined Patent Application Publication No. 2017-157004 (JP 2017-157004 A) discloses an update system for updating software of an in-vehicle device using update data received by wireless communication.

### SUMMARY

The update system performs software update with electric power supplied from a battery. For this reason, when the power supply to the update system is stopped by a user who removes a cable from a terminal of the battery during the software update, an abnormality (such as interruption of the update) may occur in the software update operation.

A vehicle for solving the above problem is a vehicle configured to update software for use in an in-vehicle device using update data received by wireless communication. The vehicle includes:
a power supply device;
a housing portion that houses the power supply device; and
a control device.

The housing portion includes:
an opening portion;
an opening and closing body configured to open or close the opening portion; and
a locking mechanism configured to lock the opening and closing body in a state in which the opening portion is closed by the opening and closing body.

The control device is configured to execute: updating the software with electric power supplied from the power supply device; and switching the locking mechanism between a locked state in which the opening and closing body is locked and an unlocked state in which the opening and closing body is not locked. Switching from the locked state to the unlocked state is not executed during update of the software.

In the above configuration, the opening and closing body is not unlocked during the update of the software. Therefore, the user cannot remove the power cable of the power supply device. Thus, an abnormality in the software update operation caused by the stop of the power supply to the control device is unlikely to occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a vehicle according to an embodiment;

FIG. 2 is a schematic diagram showing a configuration of a control device of the vehicle of FIG. 1; and

FIG. 3 is a flowchart illustrating a flow of processing executed by the control device of the vehicle of FIG. 1.

### DETAILED DESCRIPTION OF EMBODIMENTS

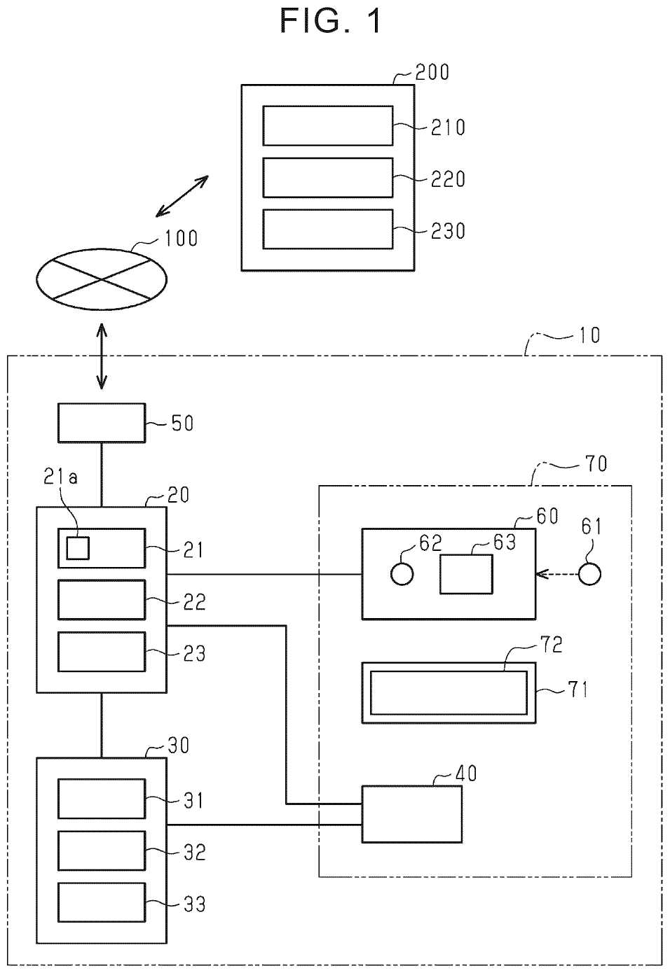

Hereinafter, an embodiment of a vehicle will be described with reference to FIGS. 1 to 3.

### Configuration of the Vehicle 10

As illustrated in FIG. 1, the vehicle 10 includes a master ECU 20 and an ECU 30. “ECU” is an abbreviation for Electronic Control Unit. The master ECU 20 manages updating of software used in the in-vehicle device. ECU 30 is an exemplary in-vehicle device of the vehicle 10. Hereinafter, a device that manages updating of software used in an in-vehicle device may be referred to as an updating device. The master ECU 20 constitutes a part of a control device 80 to be described later. The in-vehicle device is a device that operates using updatable software, and is, for example, a device that controls the driving force of the vehicle, a device that controls the braking force of the vehicle, an in-vehicle navigation device, or the like.

The master ECU 20 includes a storage device 21, a RAM 22, and a processor 23. The storage device 21 stores a program for managing the update of the software and update data for updating the software of the in-vehicle device. The storage device 21 includes a data storage 21a that stores updated data obtained from the outside. The processor 23 executes the program read from the storage device 21 by using RAM 22 as a working area, thereby updating the software of the in-vehicle device to be described later.

The vehicles 10 include a DCM 50. In addition, “DCM” is an abbreviation for Data Communication Module. The master ECU 20 is capable of wirelessly communicating with servers 200 external to the vehicles 10 via DCM 50 and communication network 100. An example of the communication network 100 is a mobile communication network.

The server 200 is a device that distributes update data. The server 200 includes a storage device 210 that stores a program for distributing update data, and a processing device 220 that executes the program for distribution. The server 200 includes a communication device 230. The communication device 230 is configured to be capable of performing wireless communication via the communication network 100.

DCM 50 receives updates from the servers 200 via radio communications over the communication network 100. The master ECU 20 receives the update-data from DCM 50. The master ECU 20 stores the updated data in the data storage 21a.

ECU 30 includes a storage device 31. The storage device 31 stores software used for ECU 30. The storage device 31 is a nonvolatile memory. The storage device 31 stores various programs in advance as software. The software includes firmware, operating software, and application software. The firmware and the operation software are software for performing basic control of hardware constituting the in-vehicle device. The application software is software for causing an in-vehicle device to perform a specific function.

ECU 30 includes a RAM 32 and a processor 33. The processor 33 executes the program read from the storage device 31 using RAM 32 as a working area.

Vehicle 10 includes a power supply device 40 configured to be capable of supplying power to a master ECU 20. DC-DC converters that charge the battery and the battery are exemplary components of the power supply device 40. The cable connected to the terminal of the battery and the cable connecting the battery and DC-DC converter are exemplary power cables of the power supply device 40.

The master ECU 20 is supplied with power from the power supply device 40 and executes a process of updating ECU 30 software. More preferably, the power supply device 40 is capable of supplying power to the storage device 31 in addition to the master ECU 20. In the present embodiment, the power supply device 40 can supply power to the storage device 31. The power supply device 40 is provided inside the engine compartment 70 of the vehicle 10. The engine compartment 70 is an example of a housing portion.

The engine compartment 70 includes an opening portion 71 and an engine hood 72. The engine hood 72 is an example of an opening and closing body that opens/closes the opening portion 71. The engine hood 72 is configured to be switchable between an open state and a closed state. When the engine hood 72 is in the open state, the opening portion 71 is opened. Accordingly, the user can access the interior of the engine compartment 70 to disconnect the power cable of the power supply device 40, such as a cable connected to a terminal of the battery or a cable between the battery and DC-DC converter. When the engine hood 72 is in the closed state, the opening portion 71 is closed by the engine hood 72. Therefore, the user cannot access the inside of the engine compartment 70 and cannot disconnect the power cable of the power supply device 40. The engine compartment 70 includes a locking mechanism 60 configured to lock the engine hood 72 in a state of closing the opening of the opening portion 71.

The locking mechanism 60 is configured to be switchable between a locked state in which the engine hood 72 is locked and an unlocked state in which the engine hood 72 is not locked. The locking mechanism 60 includes an actuator 63. The master ECU 20 is configured to be able to switch between the locked state and the unlocked state of the locking mechanism 60 by controlling the actuator 63.

The vehicle 10 includes a hood lock switch 61. When the user turns on the hood lock switch 61, the hood lock switch 61 generates an unlock signal for unlocking the locking mechanism 60. The vehicle 10 is configured to be able to switch the locking mechanism 60 to the unlocked state when the locking mechanism 60 is in the locked state when the hood lock switch 61 is turned on.

The vehicle 10 includes a lock sensor 62 that outputs a signal for determining whether the locking mechanism 60 is in a locked state or an unlocked state. This is transmitted from the lock sensor 62 to the master ECU 20. The master ECU 20 sets a flag corresponding to the locked state when a signal from the lock sensor 62 indicates that the locking mechanism 60 is in the locked state. The master ECU 20 sets a flag corresponding to the unlocked state when the signal from the lock sensor 62 indicates that the locking mechanism 60 is in the unlocked state. The flag indicating the status of the locking mechanism 60 is stored in the storage device 21 of the master ECU 20.

In the present embodiment, the storage holding of whether the locking mechanism 60 is in the locked state or the unlocked state is performed by software based on the flag operation. However, the present disclosure is not limited to the master ECU 20, and another in-vehicle device may store and hold whether the locking mechanism 60 is in the locked state or the unlocked state.

### Software Update Overview

20 An outline of updating of ECU 30 software in the vehicle 10 will be described. Software updates are made through the Download phase, Install phase, and Activate phase.

In the download phase, update data is transmitted from the server 200 to the vehicle 10. The master ECU 20 stores the updated data received from the servers 200 in the data storage 21a. The download phase includes a series of processes related to download, such as determination of whether download is executable or not, verification of update data, and the like. Transmission of the update data from the servers 200 to the master ECU 20 may be transmission of compressed data obtained by compressing the update program. In addition, the servers 200 may transmit the update program or the divided data obtained by 30 dividing the compressed data to the master ECU 20. In addition, the servers 200 may collectively transmit the updating programs of the plurality of in-vehicle devices to the master ECU 20.

In the installation phase, an update program is installed in ECU 30. In the installation phase, the master ECU 20 installs the update program in the storage device 31 of ECU 30 based on the update data downloaded to the data storage 21a. The installation phase includes a series of processes related to installation, such as determination of whether installation is executable, transfer of update data, verification of an update program, and the like. When the update data includes the update program itself rather than the compressed data or the like of the update program, the master ECU 20 transmits the update data to ECU 30 in the installation phase. Upon completion of the installation phase, the update program is disabled.

When the update data includes the compressed data, the difference data, or the divided data of the update program, a process of generating the update program from the update data is performed. The generation process may be performed by the master ECU 20 or by ECU 30. The update program can be generated by decompressing the compressed data, assembling the difference data or the divided data.

In the activation phase, the activation of the update program, i.e., the activation of the update program, is performed in ECU 30. The activation phase includes a series of processes related to activation such as determination of whether or not to execute activation, consistency check of an update program, verification of an execution result of activation, and the like.

Outline of the processing executed by the control device 80

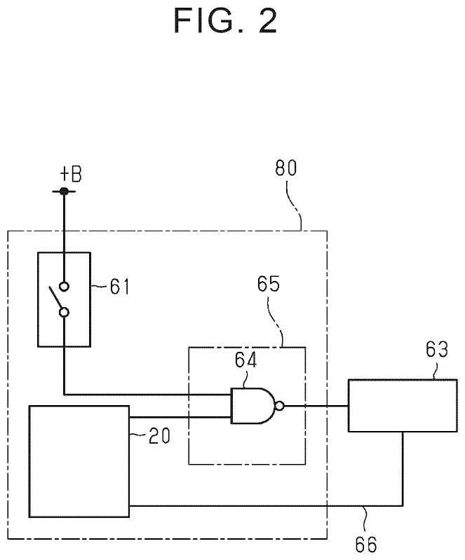

As illustrated in FIG. 2, the vehicle 10 includes a control device 80 that controls the actuator 63. The control device 80 is configured to be able to switch the locking mechanism 60 between the locked state and the unlocked state. In one example, the control device 80 includes a hood lock switch 61, a master ECU 20, and logic circuit 65. The hood lock switch 61 is always connected to a power source. For example, the hood lock switch 61 is connected to the high potential (+B) of the power supply device 40.

A logic circuit 65 is connected to an output side of the hood lock switch 61. When the hood lock switch 61 is turned on, the hood lock switch 61 outputs an H (high) level signal. This signal is input to the logic gate 64 of the logic circuit 65. In a state where the hood lock switch 61 is not turned on, the hood lock switch 61 outputs an L (low) level signal.

The logic gate 64 is a NAND gate that performs a negative AND (NAND) operation. The logic gate 64 outputs an H-level signal when at least one L-level signal is input. When only an H-level signal is input, the logic gate 64 outputs an L-level signal. The signal output from the logic gate 64 is input to the actuator 63 of the locking mechanism 60. When the signal of the L level is input, the actuator 63 operates so that the locking mechanism 60 is switched from the locked state to the unlocked state. When the signal of the H level is input, the actuator 63 does not operate so that the locking mechanism 60 is switched from the locked state to the unlocked state.

The master ECU 20 outputs an H-level signal to the logic gate 64 at all times, except during software-updating. Therefore, only the H-level signal is input to the logic gate 64 when the hood lock switch 61 is turned on, except during the software update. That is, the logic gate 64 outputs an L-level signal when the hood lock switch 61 is turned on, except during software update. As a result, the locking mechanism 60 is switched from the locked state to the unlocked state.

During the software update of ECU 30, the master ECU 20 outputs an L-level signal to the logic gate 64 indicating that the software is being updated. Therefore, when the software is being updated, even if the hood lock switch 61 outputs an H-level signal in response to the ON operation of the hood lock switch 61, the logic gate 64 does not output an L-level signal. That is, the logic circuit 65 disables the unlock signal during the software update. Therefore, the control device 80 does not switch the locking mechanism 60 from the locked state to the unlocked state during the software update.

In the present embodiment, the control for invalidating the unlock signal during updating of the software is performed in hardware through the logic circuit 65, but the control may be changed to a configuration for performing the control in software, specifically, a configuration performed by the master ECU 20.

The control device 80 includes, in addition to the above-described logic circuit 65 for outputting the unlock signal to the actuator 63, a circuit 66 for outputting a lock signal for switching the locking mechanism 60 from the unlocked state to the locked state. In one embodiment, the circuit 66 is a circuit for outputting a locking signal from the master ECU 20 to the actuator 63.

In the present disclosure, the period defined as the update of the software (hereinafter, sometimes referred to as the update period) may be any period of time from the download phase to the completion of the activation phase. That is, even when the hood lock switch 61 is turned on, the period during which the locking mechanism 60 is not switched from the locked state to the unlocked state may be any of the above-described periods. For example, the update period may be any of a download phase, an install phase, and an activate phase. In other examples, the update period is any of a download phase and an install phase, an install phase and an activate phase, and a download phase and an activate phase. In other examples, the update period is each of a download phase, an install phase, and an activate phase.

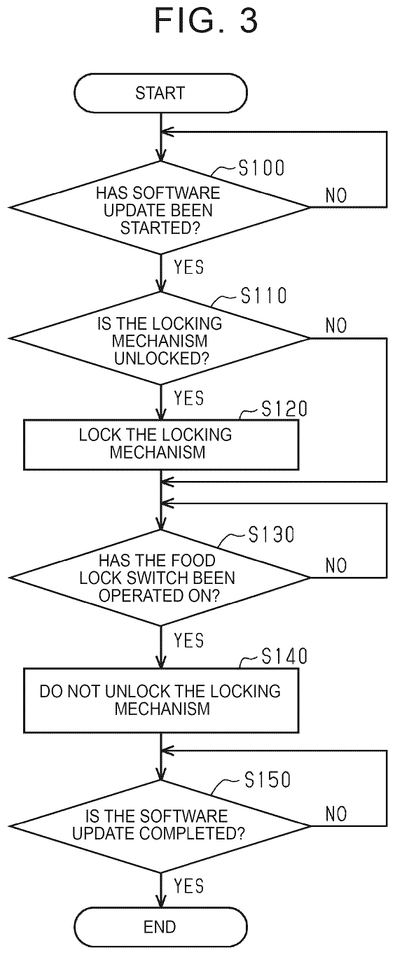

FIG. 3 shows a flow of a series of processes executed in the vehicle 10. This

series of processing is executed by the control device 80. First, when updating of the software is started (S100: YES), the master ECU 20 refers to the status of the locking mechanism 60 by the flag stored in the storage device 21 (S110). When the locking mechanism 60 is in the unlocked state (S110: YES), the master ECU 20 performs control to switch the locking mechanism 60 to the locked state (S120). That is, the master ECU 20 switches the locking mechanism 60 from the unlocked state to the locked state when the locking mechanism 60 is in the unlocked state at the beginning of updating the software. When the locking mechanism 60 is locked (S110: NO), S130 process is executed. When the software is being updated (S100: YES), even when the hood lock switch 61 is turned on (S130: YES), the control device 80 does not perform control to switch the locking mechanism 60 from the locked state to the unlocked state (S140). When the updating of the software is completed (S150: YES), the state in which the control for switching the locking mechanism 60 from the locked state to the unlocked state is not performed is ended.

### Operation and Effect of Embodiments

The operation and effects of the present embodiment will be described.

(1) During the software update, the vehicle 10 does not switch the locking mechanism 60 from the locked state to the unlocked state even when the hood lock switch 61 is turned on. Therefore, the user cannot unlock the engine hood 72 during the software update. Therefore, the user cannot disconnect the power cable of the power supply device 40. Therefore, it is possible to prevent power from being supplied to the master ECU 20. Therefore, it is difficult for an abnormality to occur in the software update operation. It is assumed that an abnormality in the update operation occurs during the update, such as when the software update is stopped in the middle, and an abnormality remains in the program as a result of the occurrence of the problem during the update.

(2) When the software update starts, the control device 80 switches the locking mechanism 60 to the locked state when the locking mechanism 60 is in the unlocked state. Therefore, even when the locking mechanism 60 of the engine compartment 70 is in the unlocked state at the start of the software update, the vehicle 10 can prevent the power supply cable of the power supply device 40 from being disconnected by the user during the software update.

(3) The control device 80 can switch the locking mechanism 60 from the locked state to the unlocked state based on an unlock signal generated in response to an operation by the user. In the vehicle 10, the unlock signal is disabled during the software update. Therefore, even if the control device 80 generates the unlock signal based on the operation of the user, the locking mechanism 60 is not switched from the locked state to the unlocked state. Therefore, it is possible to prevent the power cable from being disconnected from the power supply device 40 by the user during the software update. Modifications

The present embodiment can be realized with the following modifications. The present embodiment and the following modifications can be implemented in combination with each other as long as they are not technically contradictory.

The housing portion for accommodating the power supply device 40 may be a vehicle cabin or a luggage compartment of the vehicle 10. In the case where the housing portion is a vehicle cabin, the opening and closing body for opening and closing the opening portion for the user to get on and off is a door for getting on and off. When the housing portion is a luggage compartment, the opening and closing body for opening and closing the opening portion of the luggage compartment is a trunk hood. In the case where the housing portion is a vehicle cabin, a mechanism for locking the getting-on/off door is provided in a state of closing the opening portion of the vehicle cabin. If the housing portion is a luggage compartment, a mechanism for locking the luggage hood in a state of closing the opening portion of the luggage compartment is provided. When the locking mechanism is in the unlocked state when the user performs an operation for opening the getting-on/off door or the trunk hood, the control device 80 may execute a process of switching the locking mechanism to the locked state.

The housing portion that houses the power supply device 40 may be a case that houses the power supply device 40. In this case, the opening and closing body is a lid for opening and closing the case. An exemplary case is a case that houses both a battery and a DC-DC converter, or a case that houses either a battery or a DC-DC converter.

For example, the vehicle 10 may be capable of generating an unlock signal by an operation performed from the outside of the vehicle 10. In one example, when the electronic key system is mounted on the vehicle 10, an unlocking signal may be generated in response to the electronic key being authenticated by the vehicle 10 and the opening switch provided in the doors for getting on and off being operated. Even in this case, for example, when the housing portion is a vehicle cabin, the vehicle 10 may be configured so as not to execute a process of switching the locking mechanism of the getting-on/off door from the locked state to the unlocked state during the software update.

In the above embodiment, the power supply device 40 is capable of supplying power to both the master ECU 20 and the storage device 31. In this case, in addition to suppressing occurrence of an abnormality in the update operation due to the stoppage of the supply of power to the master ECU 20, occurrence of an abnormality in the update operation due to the stoppage of the supply of power to the storage device 31 can be suppressed. Note that the power supply device 40 only needs to be capable of supplying power to the master ECU 20. In one instance, ECU 30 may not be able to be powered.

In the above embodiment, the master ECU 20 executes the process of updating ECU 30 software. However, in an exemplary embodiment, instead of the master ECU 20, ECU 30 may execute a process of updating the software used in ECU 30.

The storage device includes one data storage area for storing software and two data storage areas for storing software. The storage device 31 includes, for example, one data storage area for storing software. The data storage area is sometimes referred to as a memory bank. In this case, the storage device 31 may be referred to as a single bank. In this case, when the update data is written to the storage device 31, the storage device 31 cannot hold the software before the update. Therefore, there is a possibility that an abnormality may remain in the program when an abnormality occurs in the software update operation in the installation phase and the activation phase.

In this case, the above-described update period is preferably a period including an installation phase and an activation phase. According to this configuration, when the storage area of the storage device 31 is one, power can be stopped from being supplied to the master ECU 20 in the install phase and the activate phase. Further, it is possible to prevent an abnormality from remaining in the program due to the stop.

The storage device 31 may include two data storage areas. When the storage device 31 includes two data storage areas, the storage device 31 may be referred to as a dual bank. In this case, one of the two data storage areas is set as the storage area to be read, and the software stored in the storage area to be read is executed. During execution of the program in the storage area to be read, the storage device 31 can write the update data in the background in the other storage area not to be read.

The storage device 31 activates the updated software by switching the storage area to be read out of the program in the activation phase. Therefore, even in a case where the storage device 31 includes two data storage areas, there may be no copy of the data of the old program and the data of the new program while the storage area to be read from the program is switched. During this time, if an abnormality occurs in the software update operation, there is a possibility that an abnormality remains in the program.

In this case, the update period is preferably a period including the activation stage. According to this configuration, when the storage device 31 includes two data storage areas, it is possible to prevent power from being supplied to the master ECU 20 during the activation phase and prevent an error from remaining in the program due to the stoppage. Therefore, it is possible to prevent an abnormality from remaining in the program.

The number of in-vehicle devices and the number of update devices to be updated by the software are arbitrary. For example, the vehicle 10 may include a plurality of in-vehicle devices to be updated with software. For example, the software of each in-vehicle device among the plurality of in-vehicle devices may be updated by one updating device, and the software of the plurality of in-vehicle devices may be updated by one updating device.

The number of power supply devices and the number of housing portions that supply power to the update device are arbitrary. For example, the vehicle 10 may include a plurality of power supply devices. For example, the vehicle 10 may include a plurality of housing portions that accommodate the respective batteries. The control device 80 may perform a process of switching between the locked state and the unlocked state with respect to the locking mechanism of each of the plurality of housing portions.

The number of control devices that execute the process of updating the software and the process of switching the state of the locking mechanism 60 is arbitrary. For example, the process of updating the software and the process of switching the state of the locking mechanism 60 are executed by different control devices. For example, one process is executed by a plurality of control devices in cooperation.

What is claimed is:

1. A vehicle configured to update software for use in an in-vehicle device using update data received by wireless communication, the vehicle comprising:
a power supply device;
a housing portion that houses the power supply device; and
a control device, wherein
the housing portion includes:
an opening portion;
an opening and closing body configured to open or close the opening portion; and
a locking mechanism configured to lock the opening and closing body in a state in which the opening portion is closed,
the control device is configured to execute:
updating the software with electric power supplied from the power supply device; and
switching the locking mechanism between a locked state in which the opening and closing body is locked and an unlocked state in which the opening and closing body is not locked, and
switching from the locked state to the unlocked state is not executed during update of the software.

2. The vehicle according to claim 1, wherein the control device is configured to switch the locking mechanism from the unlocked state to the locked state when the locking mechanism is in the unlocked state at a start of the update of the software.

3. The vehicle according to claim 1, wherein the control device is configured to execute the switching from the locked state to the unlocked state based on a signal generated in response to a user operation, and disable the signal during the update of the software.

4. The vehicle according to claim 1, wherein the housing portion is any one of an engine compartment, a trunk room, and a vehicle cabin of the vehicle.
